(19) United States
(12) Patent Application Publication
(10) Pub. No.: US 2025/0274871 A1
(43) Pub. Date: Aug. 28, 2025

(54) COMPLEMENTARY SEQUENCE OVERLAY FOR OOK-BASED LOW-POWER WAKE-UP SIGNAL

(71) Applicant: Apple Inc., Cupertino, CA (US)

(72) Inventors: Sigen YE, San Diego, CA (US); Oghenekome OTERI, San Diego, CA (US); Weidong YANG, San Diego, CA (US); Dawei ZHANG, Saratoga, CA (US); Seung Hee HAN, San Jose, CA (US); Wei ZENG, Saratoga, CA (US); Huaning NIU, San Jose, CA (US)

(21) Appl. No.: 19/064,481

(22) Filed: Feb. 26, 2025

Related U.S. Application Data
(60) Provisional application No. 63/557,906, filed on Feb. 26, 2024.

(51) Int. Cl. H04W 52/02; H04L 27/02

(52) U.S. Cl. CPC H04W 52/0235; H04L 27/02

(57) ABSTRACT

A base station may generate a low-power (LP) wake-up signal (LP-WUS) that includes on-off keying (OOK) symbols with complementary sequences overlaying at least one of the OOK symbols. The complementary sequences may include an indication of a user equipment (UE) to transition from a power saving mode to an active mode. The base station may communicate the LP-WUS to the UE, which may cause the UE to transition from the power saving mode to an active mode. The complementary sequence may include, or be generated creating, one or more Golay complementary sequences. These and many other features and examples are described herein.

### CROSS REFERENCE TO RELATED APPLICATIONS

This application claims the benefit of U.S. Provisional Application No. 63/557,906, filed Feb. 26, 2024, the content of which is herein incorporated by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fourth generation (4G), fifth generation (5G) or new radio (NR) technology. Such technology may include solutions for enabling user equipment (UE) and network devices, such as base stations, to communicate with one another. Some scenarios may involve signaling related to a UE transitioning in and out of power saving modes of operation.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example of an overview of dynamic waveform switching (DWS) in a multi-cell environment according to one or more implementations described herein.

FIG. 2 is a diagram of an example network according to one or more implementations described herein.

FIG. 3 is a diagram of an example of Golay sequence generation using sets of W and D vectors according to one or more implementations described herein.

FIG. 4 is a diagram of an example of overlay sequence generation using a Golay sequence and one or more Walsh-Hadamard rows according to one or more implementations described herein.

FIG. 5 is a diagram of an example overlay sequence generation using pairs of Golay sequences and one or more Walsh-Hadamard rows according to one or more implementations described herein.

FIG. 6 is a diagram of an example of all cells using a single complementary sequence set to overlay on-off keying (OOK) signals according to one or more implementations described herein.

FIG. 7 is a diagram of an example of cells using different complementary sequences to overlay OOK signals according to one or more implementations described herein.

FIG. 8 is a diagram of an example of cells using a complementary sequence and one or more Walsh-Hadamard rows to overlay OOK signals according to one or more implementations described herein.

FIG. 9 is a diagram of an example of cell groups using complementary sequence subsets and hopping patterns to overlay OOK signals according to one or more implementations described herein.

FIG. 10 is a diagram of an example process for using a complementary sequence overlay for an OOK-based, low-power (LP) wake-up signal (WUS) according to one or more implementations described herein.

FIG. 11 is a diagram of an example process for using a complementary sequence overlay for an OOK-based, LP-WUS according to one or more implementations described herein.

FIG. 12 is a diagram of an example of components of a device according to one or more implementations described herein.

FIG. 13 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and/or other network access nodes. UEs and base stations may implement various techniques and communications standards for enabling UEs and base stations to discover one another, establish and maintain connectivity, and exchange information in an ongoing manner. An aspect of interest in telecommunications may include ensuring that signals and devices are designed with efficiency in mind.

A UE may consume many milliwatts of power, even when the UE is not actively transmitting or receiving any information. This unnecessary power consumption may be due, for example, to the UE performing periodic measurements and checking for potential paging messages. Implementation of UEs without an external power source (including Internet-of-Things (IoT) devices) may therefore be limited. As such, UEs may be designed with a low power (LP) wake-up signal (WUS) receiver (WUR) to operate independent of a main radio (MR) component, such that the MR component may be powered off while the LP-WUR component remains active and searching for a potential WUS during an idle mode or inactive mode (collectively referred to herein as a power saving mode). A WUS may cause a UE to transition from a power saving mode to an active mode, where the MR monitors, for example, for paging.

On-off keying (OOK) may include a modulation technique that may be implemented by a LP-WUR of a UE. OOK may involve a type of amplitude shift keying (ASK) involving only two amplitudes, an “on” amplitude and an “off” amplitude. Envelope detection may be used to determine whether an OOK symbol indicates “on” (or “1”) or off (or “0”). When applied to a multi-carrier scenario, such as orthogonal frequency division multiplexing (OFDM), OOK may be referred to as multi-carrier (MC) OOK as “on” signals may span multiple subcarriers (SC).

MC OOK may include different schemes, such as OOK-1, OOK-2, and OOK-4. OOK-1 may include an MC-OOK scheme. The presence of signals on one or multiple subcarriers at an OOK-specified OFDM symbol may indicate a “1” and an absence may indicate a “0”. OOK-2 may include an MC-OOK scheme where more than 1 bits are carried by an OFDM symbols using multiple sets of subcarriers, where each set of subcarriers uses OOK-1. OOK-4 may include an MC-OOK scheme where an OOK comprises multiple bits corresponding to 1 OFDM symbol, by dividing 1 OFDM symbol duration into multiple time segments, and each time segment carries 1-bit OOK. A time-domain signal may be transformed into a frequency domain (e.g., via discrete Fourier transform (DFT) or least square precoding) before being mapped onto an OFDM resource grid. For these MC OOK schemes, when the signal for an OOK bit “1” is generated, it can be represented by a sequence of time samples (i.e., a time-domain sequence) for OOK-1 and OOK-4, or a sequence of signals on multiple subcarriers (i.e. a frequency-domain sequence) for OOK-1. The time-domain or frequency-domain sequence is also called an overlay sequence (also referred to herein as an “overlaid sequence”) on an OOK symbol.

The techniques described herein may enable a LP-WUR to be simple and use minimal power when searching for, receiving, and processing a WUS. These techniques may enable an OOK-based LP-WUS to carry the same information regardless of whether an LP-WUR is an OOK-based receiver or a sequence-based receiver. An OOK-based receiver may include a LP-WUR configured to perform OOK symbol detection without knowledge of an overlay sequence. A sequence-based receiver may include a LP-WUR configured to perform sequence detection for an overlay sequence in either a time or frequency domain. As such, an OOK-based receiver may properly receive the LP-WUS because of the base OOK symbol, and a sequence-based receiver may properly receive the same LP-WUS because of the sequence overlaying the OOK symbol in either the time or frequency domain.

An overlay sequence (also referred to herein as an “overlaid sequence”) may include a Golay complementary sequence, or another type of complementary sequence, that may carry wake up instructions in an OOK symbol of a LP-WUS. When an OOK signal is generated, each OOK bit or symbol of “1” may have a corresponding waveform. An OOK bit of “0” may corresponds to a scenario without any signal transmitted. An overlay sequence may refer to how the waveform is generated. For example, in a time domain, each OOK bit or symbol of “1” may have a certain time duration. In a discrete-time domain, the waveform of an overlay sequence may include a number of time samples, each sample having a corresponding value (e.g., 1 or 0). An overlay sequence may refer to the values of these time samples within one OOK symbol of “1”. For example, if one OOK symbol has 32 time samples, the overlay sequence may have a length of 32. A Golay sequence may be used as the overlay sequence. The overlay sequence may also be represented in a frequency domain for OOK-1, which may refer to the symbols of the N subcarriers used for indicating OOK. For an OOK-based receiver, the waveform of an overlay sequence may not matter. Instead, the OOK-based receiver may perform envelop detection to determine whether an OOK signal has been transmitted. By contrast, a sequence-based receiver may perform sequence correlation (e.g., via a Golay correlator) on the overlay sequence of the OOK symbol and do the sequence detection to determine whether a wake-up instruction has been transmitted and received.

Complementary sequences may include pairs of sequences with out-of-phase auto-correlation coefficients that sum to zero. Complementary sequences may be determined by applying an autocorrelation function. The sum of an autocorrelation function, of complementary sequences, may be a delta function. As an example, for complementary sequences of length 2: (+1, +1) and (+1, −1), the autocorrelation functions may be (2, 1) and (2, −1), which may add up to (4, 0). As another example, for complementary sequences of length 4: (1, +1, +1, −1) and (+1, +1, −1, +1), the corresponding autocorrelation functions may be (4, 1, 0, −1) and (4, −1, 0, 1), which may add up to (8, 0, 0, 0). Golay complementary sequences may be a type of complementary sequences. A pair of binary Golay complementary sequences may have a length of N=2^{K}, where N is a number of subcarriers. A pair of binary Golay complementary sequences (Aₖ(n) and Bₖ(n)) may be generated recursively. An example of this may be represented as follows:

$${A}_{0} ( n ) = δ ( n )$$

$${B}_{0} ( n ) = δ ( n )$$

$${A}_{k} ( n ) = {W}_{k} {A}_{k - 1} ( n ) + {B}_{k - 1} ( n - {D}_{k} )$$

$${B}_{k} ( n ) = {W}_{k} {A}_{k - 1} ( n ) - {B}_{k - 1} ( n - {D}_{k} )$$

where n may be an index from 1, . . . , N for the sequence elements; δ(n) may be a delta function; k may be an iteration-index from 1, . . . , K; Wₖ may be ∈{1, −1}, and Dₖ may be a delay represented by 2^{P}^{ₖ}, where P is a permutation of {0, 1, . . . , K−1}. Different sets of Wₖ and Dₖ vectors may result in different pairs of Golay complementary sequences. A Golay correlator may be used for the detection of Golay sequences. A Golay correlator may be used for the detection of Golay sequence(s), not the generation. Using a Golay correlator, complementary sequences may be detected via correlation more efficiently than with other correlation approaches. For example, for complementary sequences with a length of 2^{N}, correlation between a complementary pair may be determined with only 2×N addition/subtraction operations, whereas other correlation approaches may involve many more operations. Such sequences may also be referred to as Golay sequences.

The techniques described herein may further enable a large number of possible sequences and subcarrier arrangements (or hopping patterns) as Golay complementary sequences may have a length (N) of 2^{K}, where N is a number of subcarriers used. This may also provide flexibility in terms of the number of sequences per serving cell and how sequences are allocated to serving cells. The number of Golay sequences for each serving cell may depend on how many bits of information are to be included in the overlay sequence of an OOK symbol. For example, when 0/1/2/3-bit information is carried, 1/2/4/8 sequences may be used for each OOK symbol. The number of Golay sequences may also depend on whether there is sequence hopping between different OOK symbols and the hopping pattern. When hopping occurs within the same set of sequences, there may be no increase in the number of sequences used. When hopping occurs between different sets of sequences, more sequences may be used. While one or more of the techniques described herein may involve a Golay sequence, the techniques described herein may also, or alternatively use, another type of complementary sequence (CS), such as polyphase complementary sequences, multilevel complementary sequences, and arbitrary complex complementary sequences. Complementary sets, including more than two complementary sequences, may also be used.

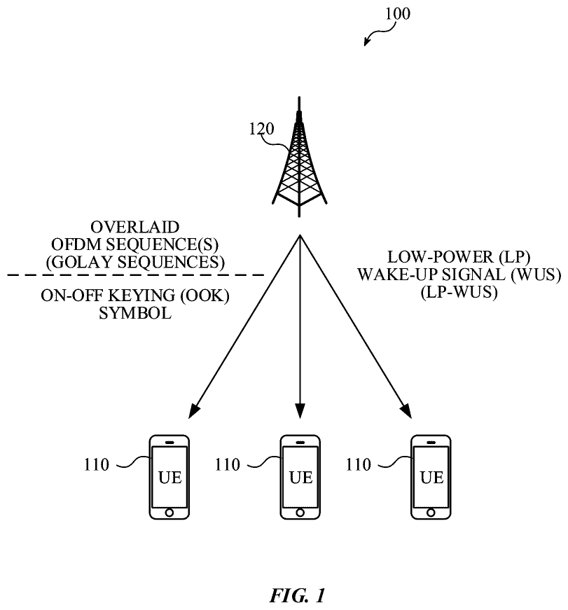

FIG. 1 is a diagram of an example of an overview 100 according to one or more implementations described herein. As shown, UEs 110 may receive a LP-WUS from base station 120. The LP-WUS may include one or multiple OFDM symbols that includes one or more OOK symbols. Each OOK symbol may include one or more candidate overlay sequences to choose from. Each overlay sequence may include a sequence of values distributed in a time domain or a frequency domain. When distributed in a time domain, the overlay sequence may include a number of time samples distributed over the time domain of the underlying OOK symbol, and each time sample may include a value. When distributed in a frequency domain, the overlay sequence may include one or more subcarriers carrying values of the overlay sequence. In some implementations, the overlay sequences may be subject to a hopping pattern where different candidate overlay sequences may be used at different times.

As described herein, the overlay sequence may be based on different pairs of vectors (referred to herein as W and D vector pairs), based on a combination of Golay sequences and Walsh-Hadamard matrix rows, or a combination thereof. Additionally, or alternatively, overlay sequences may be allocated to base stations (e.g., cells) according to one or more allocation schemes. Examples of these allocation schemes may include all base stations of a network using the same overlay sequences, different cells using different overlay sequences, and cells using overlay sequences according to sequence hopping patterns. These and other features are described additional detail with reference to remaining Figures.

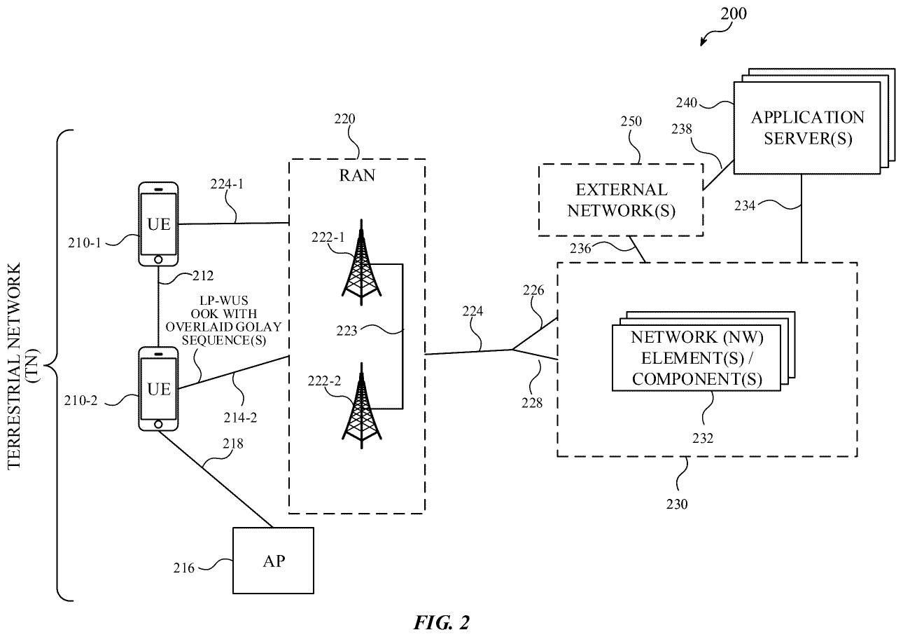

FIG. 2 is an example network 200 according to one or more implementations described herein. Example network 200 may include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, SL connection, etc. The connection may involve a PC5 interface. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210 may communicate with RAN node 222 to request SL resources. RAN node 222 may respond to the request by providing UE 210 with a dynamic grant (DG) or configured grant (CG) regarding SL resources. A DG may involve a grant based on a grant request from UE 210. A CG may involve a resource grant without a grant request and may be based on a type of service being provided (e.g., services that have strict timing or latency requirements). UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with (e.g., be communicatively coupled) with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222.

As described herein, UE 210 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 2, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink and downlink dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 may operate using stand-alone unlicensed operation, licensed assisted access (LAA), eLAA, and/or feLAA mechanisms. In these implementations, UEs 210 and the RAN nodes 222 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) may be performed at any of the RAN nodes 222 based on channel quality information fed back from any of UEs 210. The downlink resource assignment information may be sent on the PDCCH used for (e.g., assigned to) each of UEs 210.

One or more of the techniques, described herein, may enable a LP-WUS to include OOK symbols with complementary sequences overlaying at least one of the OOK symbols. The complementary sequences may include an indication for UE 210 to transition from a power saving mode (e.g., an IDLE or INNACTIVE mode) to an active mode (e.g., a CONNECTED mode). Base station 222 may communicate the LP-WUS to UE 210, which may cause UE 210 to transition from the power saving mode to an active mode. The complementary sequence may include, or be generated creating, one or more Golay complementary sequences. Many other features and examples are discussed herein.

The RAN nodes 222 may be configured to communicate with one another via interface 223. In implementations where the system is an LTE system, interface 223 may be an X2 interface. In NR systems, interface 223 may be an Xn interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 may also, or alternatively, be configured to support one or more communication services (e.g., voice over IP (VOIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

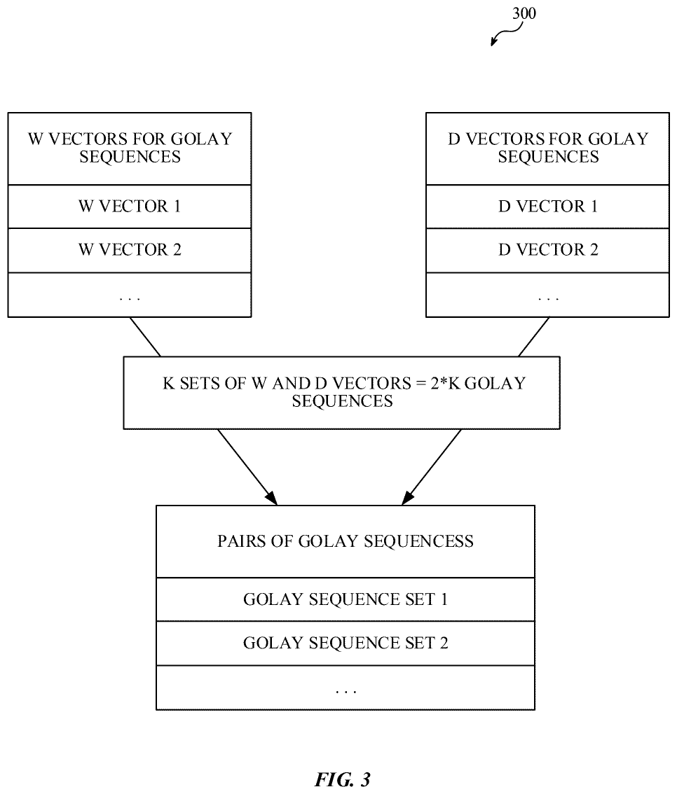

FIG. 3 is a diagram of an example of Golay sequence generation using sets of W and D vectors according to one or more implementations described herein. Base station 222 may generate Golay sequences to overlay OOK symbols. Base station 222 may use W vectors and D vectors to generate Golay sequences used to overlay OOK symbols. One OFDM symbol may include (in a time domain) one or many OOK symbols, and each OOK symbol may have only one overlay sequence, which may be chosen from multiple candidate sequences depending on the payload. An OOK-1 scenario may involve an OOK status being indicated by a single bit of an OFDM symbol. An OOK-4 scenario may involve multiple OOK statuses being indicated by multiple bits in an OFDM symbol. In some implementations, overlay sequences may only be applied to bits indicating an “on” or “1” OOK status, such that overlay sequences are not applied to bits indicating an “off” or “0” OOK status. This may be because an “off” or “0” OOK status may be indicated by a lack of an OOK signal.

Base station 222 may use K sets of W and D vectors to generate 2×L Golay sequences (or L pairs of Golay sequences). Each Golay sequence may have a length N=2K. A large number of Golay complementary sequence pairs may be generated. UE 210 may select Golay complementary sequence pairs that have good cross-correlation property, e.g. with cross-correlation coefficients below a corresponding threshold. In some implementations, UE 210 may select one Golay sequence out of each Golay complementary sequence pair, such that L Golay sequences are available for overlay purposes. The number of Golay complementary sequence pairs may be based on the number of bits to be carried on the overlay sequence of an OOK symbol. Non-limiting examples of W and D vectors that may be used to generate a Golay sequence of different lengths are as follows.

### Overlay Sequence Length=128 Bits

W=[−1, −1, −1, −1, 1, −1, −1]; D=[1, 8, 2, 4, 16, 32, 64]
W=[−1, 1, −1, −1, 1, −1, −1]; D=[2, 8, 1, 4, 16, 64, 32]
W=[1, 1, −1, 1, 1, −1, −1]; D=[4, 2, 8, 1, 64, 16, 32]
W=[−1, 1, −1, 1, 1, −1, −1]; D=[2, 4, 8, 16, 1, 64, 32]

### Overlay Sequence Length=64 Bits

W=[1, 1, −1, −1, 1, −1]; D=[2, 1, 4, 8, 16, 32]
W=[−1, 1, −1, −1, 1, −1]; D=[1, 4, 2, 8, 16, 32]
W=[1, 1, −1, 1, 1, 1]; D=[8, 2, 1, 4, 32, 16]
W=[−1, −1, −1, −1, 1, −1]; D=[16, 2, 4, 8, 1, 32]

### Overlay Sequence Length=32 Bits

W=[1, 1, −1, 1, −1]; D=[1, 4, 8, 2, 16]
W=[−1, −1, −1, 1, −1]; D=[1, 4, 2, 8, 16]
W=[1, 1, −1, 1, −1]; D=[4, 8, 1, 2, 16]
W=[−1, −1, −1, 1, −1]; D=[4, 2, 1, 8, 16]

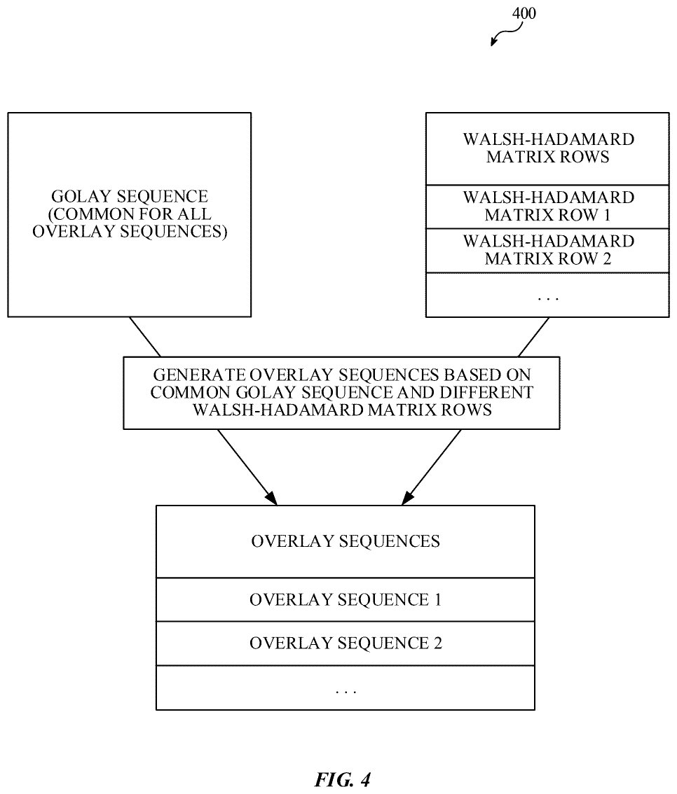

FIG. 4 is a diagram of an example of overlay sequence generation using a Golay sequence and one or more Walsh-Hadamard rows according to one or more implementations described herein. UE 210 may generate overlay sequences by generating a pair of Golay complementary sequences. UE 210 may select one Golay sequence from the pair of Golay complementary sequences and may generate a Walsh-Hadamard matrix. UE 210 may generate an overlay sequence as a dot product of the one (or common) Golay sequence and a different row of the Walsh-Hadamard matrix. A dot product (or scalar product) may include an algebraic operation that involves two equal-length sequences of numbers (e.g., a Golay sequence and a row of a Walsh-Hadamard matrix), and returns a sequence of the same length by multiplying the corresponding entries in the two sequences.

As an example, UE 210 may generate a Golay sequence with a length of 32 based using the vectors: W=[1, 1, −1, 1, −1] and D=[1, 4, 8, 2, 16]. This may produce the following 32-length Golay sequence.
[1, −1, 1, −1, 1, 1, 1, 1, −1, 1, 1, −1, 1, 1, −1, −1, 1, −1, −1, 1, 1, 1, −1, −1, −1, 1, −1, 1, 1, 1, 1, 1]

UE 210 may also generate a 32×32 Walsh-Hadamard matrix. UE 210 may generate 32 overlay sequences based on one selected Golay sequence and each row of the Walsh-Hadamard matrix (e.g. row 1, 2, . . . 32). UE 210 may generate a different number of overlay sequences using a corresponding number of rows of the Walsh-Hadamard matrix. For example, UE 210 may generate 8 overlay sequences using the selected Golay sequence and 8 different rows of the 32×32 Walsh-Hadamard matrix (e.g., every 4th row).

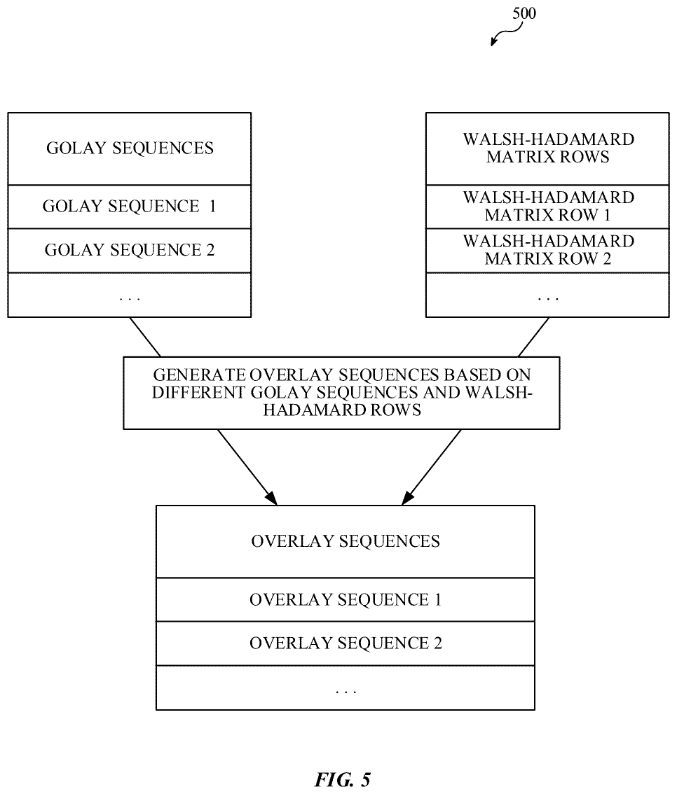

FIG. 5 is a diagram of an example overlay sequence generation using pairs of Golay sequences and one or more Walsh-Hadamard rows according to one or more implementations described herein. UE 210 may generate (M) overlay sequences by generating a number (L) of Golay complementary sequences using multiple sets of W and D vectors. UE 210 generate a N×N Walsh-Hadamard matrix, where N is the length of the overlay sequence. In some implementations, M/L rows may be chosen from the Walsh-Hadamard matrix for each Golay sequence. UE 210 may generate the overlay sequences as dot products of a combination of the Golay sequences and rows of the Walsh-Hadamard matrix.

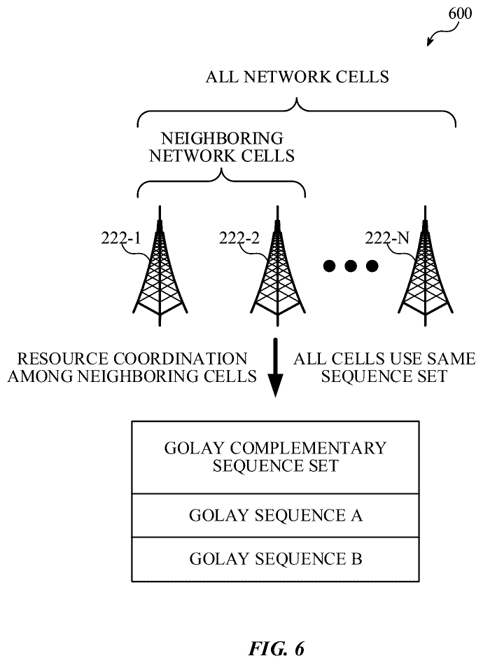

FIG. 6 is a diagram of an example 600 of all cells using a single complementary sequence set to overlay on-off keying (OOK) signals according to one or more implementations described herein. A network may include multiple base stations 222-1, 222-2, . . . , 222-N. In some implementations, all base stations 222 in the network may use the same set of Golay complementary sequences (e.g., Golay sequence A and Golay sequence B). This may enable a large number of sequences to be available for use in each cell as a relatively large number of information bits may be overlaid on each OOK symbol. In turn, this may enable UE 210 to detect an LP-WUS earlier (e.g., during the overlay sequence of a first OOK symbol instead of a later OOK symbol). To ensure that UE 210 is able to differentiate between Golay sequences of neighboring cells, neighboring base stations 222 may coordinate with one another regarding resource allocation and/or use orthogonal time/frequency resources for LP-WUS transmissions.

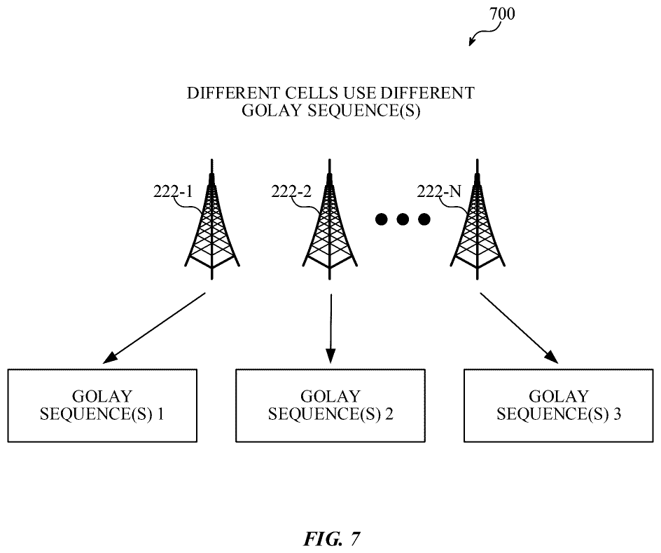

FIG. 7 is a diagram of an example 700 of cells using different complementary sequences to overlay OOK signals according to one or more implementations described herein. A network may include multiple base stations 222-1, 222-2, . . . , 222-N. In some implementations, different base stations 222 (or cells) may use different sets of Golay sequences (e.g., Golay sequence set 1, Golay sequence set 2, . . . , Golay sequence set N) to overlay OOK symbols. Using different sequences may be particularly helpful in enabling UE 210 may determine whether a LP-WUS is transmitted from a base station 222 serving UE 210.

Sequences available to base stations 222 of a network may be divided or arranged into S sets of Golay sequences, and each cell or base station 222 may be configured to use one set of Golay sequences. Each set of Golay sequences may also be associated with a set index (e.g., set index 1, set index 2, . . . , set index N). Each base station 222 may be assigned a set index, which may be indicated to UE 210. Doing so may enable UE 210 to determine which Golay sequences and/or LP-WUS corresponds to a serving base station 222 of UE 210.

Alternatively, a function may be implemented to map a cell ID of base station 222 to a set index. For example, the function may map a set index as being equal to a cell ID mod S, where “mod” is the modular operation. In another example, the function may map a set index as being equal to a “predefined number of bits of a Cell ID” mod S. In another example, a hashing function may be implemented to map a cell ID to a set index. In some implementations, a pair of Golay complementary sequences may be associated to the same set index. Doing so may enable the same Golay correlator to be used to calculate or determine the correlation with both sequences, which may help reduce receiver complexity.

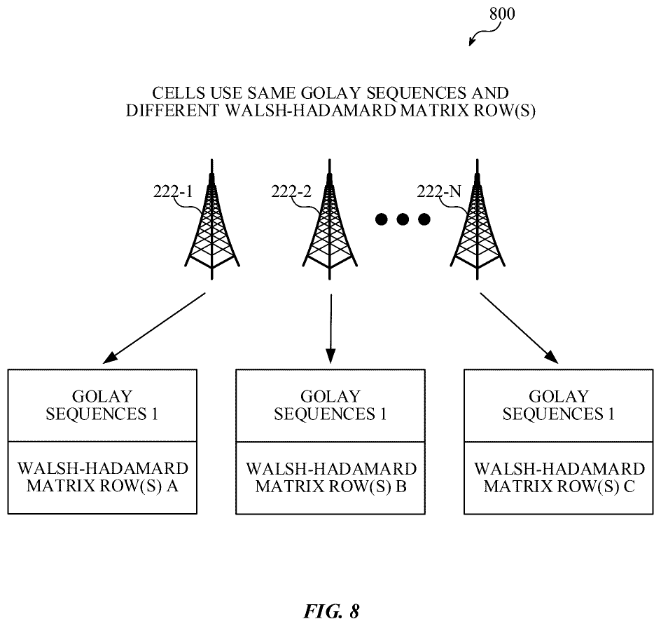

FIG. 8 is a diagram of an example 800 of cells using a complementary sequence and one or more Walsh-Hadamard rows to overlay OOK signals according to one or more implementations described herein. A network may include multiple base stations 222-1, 222-2, . . . , 222-N. In some implementations, each base station 222 (or cell) may use a different Golay sequence (as opposed to a Golay sequence set). Additionally, the single Golay sequence may carry no additional information. The Golay sequence used by each base station 222 may be based on a cell ID of base station 222. In some implementations, each base station 222 (or cell) may use a different pair of Golay sequences (e.g., a different pair of Golay complementary sequences). One bit of information is carried by the sequence. Each sequence may carry 1 bit of information. Additionally, the pair of Golay sequences used by each base station 222 may be based on a cell ID of base station 222.

As shown, each base station 222 may use the same pair or set of Golay sequences (e.g., Golay sequence set 1). Assume that a Golay sequence length (N) is 128 bits, and each base station 222 uses 8 Golay sequences. In such a scenario, 3 bits of information may be carried by a Golay sequence. The 8 Golay sequences may be created as described above, with 2 Golay sequences (e.g., a pair of Golay complementary sequences) and 4 rows of a Walsh-Hadamard matrix. The same 2 Golay sequences may be used by all base stations 222, and each base station 222 may determine the 4 rows of the Walsh-Hadamard matrix to be used based on a cell ID of base station 222. This may enable 32 sets of sequences to be used by different base stations 222.

In another implementations, each base station 222 may determine a pair of Golay sequences based on a cell ID of the base station. Assume that a Golay sequence length (N) is 128 bits, and each base station 222 uses 8 Golay sequences. In such a scenario, 3 bits of information may be carried by a Golay sequence. The 8 Golay sequences may be created as described above, with 2 Golay sequences (e.g., a pair of Golay complementary sequences) and 4 rows of a Walsh-Hadamard matrix. Different 2 Golay sequences may be used by different base stations 222 based on a cell ID of the base station, and each base station 222 may determine the 4 rows of the Walsh-Hadamard matrix to be used based on a cell ID of base station 222. In some implementations, a first part of the cell ID may be used to determine the pair of Golay sequences, and a second part of the cell ID may be used to determine the rows of the Walsh-Hadamard matrix. In other implementations, the pair of Golay sequences may be determined using: Cell ID mod J; and the rows of the Walsh-Hadamard matrix may be determined using: floor (cell ID/J), where J is number of Golay sequences or Golay sequence pairs available for use.

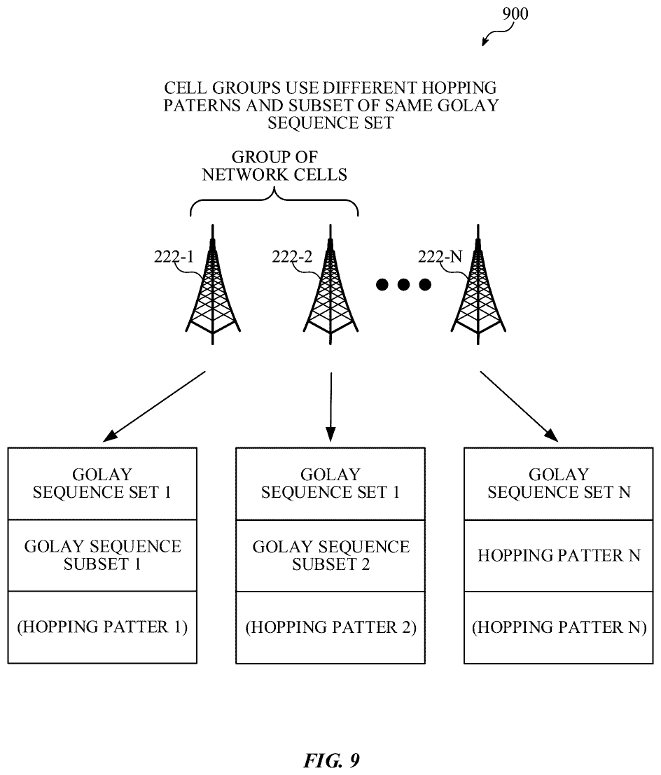

FIG. 9 is a diagram of an example 900 of cell groups using complementary sequence subsets and hopping patterns to overlay OOK signals according to one or more implementations described herein. A network may include multiple base stations 222-1, 222-2, . . . , 222-N. In some implementations, base stations 222 (or cells) may be organized or arranged into groups and may use different Golay sequence subsets or hopping patterns to overlay OOK symbols. As shown, a group of base stations that include base stations 222-1 and 222-2 may each use different Golay sequence subsets (e.g., Golay sequence subset 1 and Golay sequence subset 2) of the same Golay sequence set (e.g., Golay sequence set 1) to overlay OOK symbols at a time. Additionally, the Golay sequence subsets used by a base station may correspond to a hopping pattern (e.g., hopping pattern 1 and hopping pattern 2).

When sequence hopping is supported and the hopping occurs across different sequence sets, there may be a large set of sequences shared by a group of base stations 222, and each base station 222 may use a different hopping pattern. For example, assume that Golay sequences are divided into S subsets. Base station 222 may use one of the S subsets for each OOK symbol. The hopping pattern (i.e., which subset is used for each OOK symbol) may depend on at least one or more of a cell ID, a slot index, an OFDM symbol index, an OOK symbol index, and an ID indicated by the base station 222. In some implementations, the sequence subset may change every slot, every OFDM symbol, or every OOK symbol. Additionally, or alternatively, there may be multiple large sets of sequences, and each set may be shared by multiples base stations 222 with sequence hopping enabled.

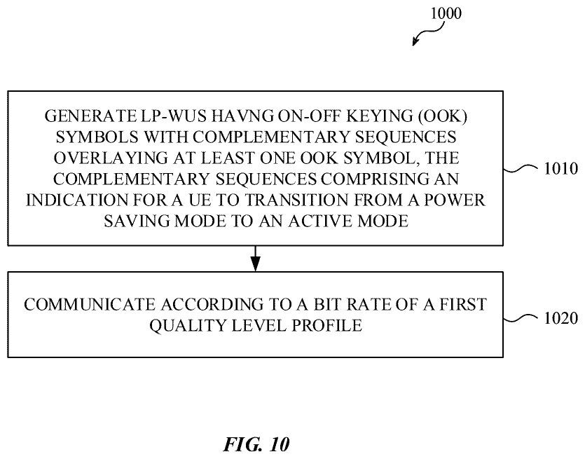

FIG. 10 is a diagram of an example process 1000 for using a complementary sequence overlay for an OOK-based, LP-WUS according to one or more implementations described herein. Process 1000 may be implemented by base stations 222. In some implementations, some or all of process 1000 may be performed by one or more other systems or devices, including one or more of the devices of FIG. 2. Additionally, process 1000 may include one or more fewer, additional, differently ordered and/or arranged operations than those shown in FIG. 10. In some implementations, some or all of the operations of process 1000 may be performed independently, successively, simultaneously, etc., of one or more of the other operations of process 1000. As such, the techniques described herein are not limited to a number, sequence, arrangement, timing, etc., of the operations or processes depicted in FIG. 10.

Process 1000 may include generating a LP-WUS that includes one or more on-off keying (OOK) symbols with one or more complementary sequences overlaying at least one OOK symbol of the one or more OOK symbols (block 1010). The he LP-WUS may include an indication for UE 210 to transition from a power saving mode to an active mode. Process 1000 may include communicating the LP-WUS to the UE (block 1020). Process 1000 may also, or alternatively, include one or more operations, features, or examples described herein.

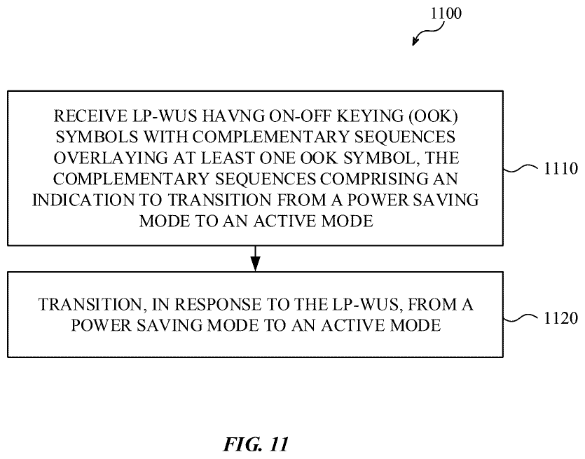

FIG. 11 is a diagram of an example process 1100 for using a complementary sequence overlay for an OOK-based, LP-WUS according to one or more implementations described herein. Process 1100 may be implemented by UE 210. In some implementations, some or all of process 1100 may be performed by one or more other systems or devices, including one or more of the devices of FIG. 2. Additionally, process 1100 may include one or more fewer, additional, differently ordered and/or arranged operations than those shown in FIG. 11. In some implementations, some or all of the operations of process 1100 may be performed independently, successively, simultaneously, etc., of one or more of the other operations of process 1100. As such, the techniques described herein are not limited to a number, sequence, arrangement, timing, etc., of the operations or processes depicted in FIG. 11.

Process 1100 may include receiving, from a base station, a LP-WUS that includes one or more on-off keying (OOK) symbols with one or more complementary sequences overlaying at least one OOK symbol of the one or more OOK symbols (block 1110). The one or more complementary sequences may include an indication for UE 210 to transition from a power saving mode to an active mode. Process 1100 may include transitioning, in response to the LP-WUS, from a power saving mode to an active mode (block 1120). Process 1100 may also, or alternatively, include one or more operations, features, or examples described herein.

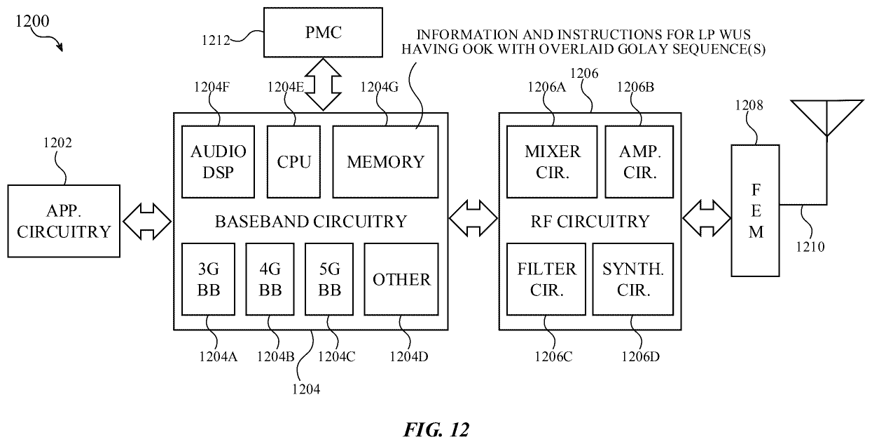

FIG. 12 is a diagram of an example of components of a device according to one or more implementations described herein. In some implementations, the device 1200 can include application circuitry 1202, baseband circuitry 1204, RF circuitry 1206, front-end module (FEM) circuitry 1208, one or more antennas 1210, and power management circuitry (PMC) 1212 coupled together at least as shown. The components of the illustrated device 1200 can be included in a UE or a RAN node. In some implementations, the device 1200 can include fewer elements (e.g., a RAN node may not utilize application circuitry 1202, and instead include a processor/controller to process IP data received from a CN or an Evolved Packet Core (EPC)). In some implementations, the device 1200 can include additional elements such as, for example, memory/storage, display, camera, sensor (including one or more temperature sensors, such as a single temperature sensor, a plurality of temperature sensors at different locations in device 1200, etc.), or input/output (I/O) interface. In other implementations, the components described below can be included in more than one device (e.g., said circuitries can be separately included in more than one device for Cloud-RAN (C-RAN) implementations).

The application circuitry 1202 can include one or more application processors. For example, the application circuitry 1202 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1200. In some implementations, processors of application circuitry 1202 can process IP data packets received from an EPC.

The baseband circuitry 1204 can include circuitry such as, but not limited to, one or more single-core or multi-core processors. The baseband circuitry 1204 can include one or more baseband processors or control logic to process baseband signals received from a receive signal path of the RF circuitry 1206 and to generate baseband signals for a transmit signal path of the RF circuitry 1206. Baseband circuitry 1204 can interface with the application circuitry 1202 for generation and processing of the baseband signals and for controlling operations of the RF circuitry 1206. For example, in some implementations, the baseband circuitry 1204 can include a 3G baseband processor 1204A, a 4G baseband processor 1204B, a 5G baseband processor 1204C, or other baseband processor(s) 1204D for other existing generations, generations in development or to be developed in the future (e.g., 5G, 6G, etc.). The baseband circuitry 1204 (e.g., one or more of baseband processors 1204A-D) can handle various radio control functions that enable communication with one or more radio networks via the RF circuitry 1206. In other implementations, some or all of the functionality of baseband processors 1204A-D can be included in modules stored in the memory 1204G and executed via a Central Processing Unit (CPU) 1204E. The radio control functions can include, but are not limited to, signal modulation/demodulation, encoding/decoding, radio frequency shifting, etc. In some implementations, modulation/demodulation circuitry of the baseband circuitry 1204 can include Fast-Fourier Transform (FFT), precoding, or constellation mapping/de-mapping functionality. In some implementations, encoding/decoding circuitry of the baseband circuitry 1204 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1204G may receive and/or store information and instructions for enabling a LP-WUS to include OOK symbols with complementary sequences overlaying at least one of the OOK symbols. The complementary sequences may include an indication for UE 210 to transition from a power saving mode (e.g., an IDLE or INNACTIVE mode) to an active mode (e.g., a CONNECTED mode). Base station 222 may communicate the LP-WUS to UE 210, which may cause UE 210 to transition from the power saving mode to an active mode. The complementary sequence may include, or be generated creating, one or more Golay complementary sequences. Many other features and examples are discussed herein.

In some implementations, the baseband circuitry 1204 can include one or more audio digital signal processor(s) (DSP) 1204F. The audio DSPs 1204F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1204 and the application circuitry 1202 can be implemented together such as, for example, on a system on a chip (SOC).

In some implementations, the baseband circuitry 1204 can provide for communication compatible with one or more radio technologies. For example, in some implementations, the baseband circuitry 1204 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1204 is configured to support radio communications of more than one wireless protocol can be referred to as multi-mode baseband circuitry.

RF circuitry 1206 can enable communication with wireless networks using modulated electromagnetic radiation through a non-solid medium. In various implementations, the RF circuitry 1206 can include switches, filters, amplifiers, etc. to facilitate the communication with the wireless network. RF circuitry 1206 can include a receive signal path which can include circuitry to down-convert RF signals received from the FEM circuitry 1208 and provide baseband signals to the baseband circuitry 1204. RF circuitry 1206 can also include a transmit signal path which can include circuitry to up-convert baseband signals provided by the baseband circuitry 1204 and provide RF output signals to the FEM circuitry 1208 for transmission.

In some implementations, the receive signal path of the RF circuitry 1206 can include mixer circuitry 1206A, amplifier circuitry 1206B and filter circuitry 1206C. In some implementations, the transmit signal path of the RF circuitry 1206 can include filter circuitry 1206C and mixer circuitry 1206A. RF circuitry 1206 can also include synthesizer circuitry 1206D for synthesizing a frequency for use by the mixer circuitry 1206A of the receive signal path and the transmit signal path. In some implementations, the mixer circuitry 1206A of the receive signal path can be configured to down-convert RF signals received from the FEM circuitry 1208 based on the synthesized frequency provided by synthesizer circuitry 1206D. The amplifier circuitry 1206B can be configured to amplify the down-converted signals and the filter circuitry 1206C can be a low-pass filter (LPF) or band-pass filter (BPF) configured to remove unwanted signals from the down-converted signals to generate output baseband signals. Output baseband signals can be provided to the baseband circuitry 1204 for further processing. In some implementations, the output baseband signals can be zero-frequency baseband signals, although this is not a requirement. In some implementations, mixer circuitry 1206A of the receive signal path can comprise passive mixers, although the scope of the implementations is not limited in this respect.

In some implementations, the mixer circuitry 1206A of the transmit signal path can be configured to up-convert input baseband signals based on the synthesized frequency provided by the synthesizer circuitry 1206D to generate RF output signals for the FEM circuitry 1208. The baseband signals can be provided by the baseband circuitry 1204 and can be filtered by filter circuitry 1206C.

In some implementations, the mixer circuitry 1206A of the receive signal path and the mixer circuitry 1206A of the transmit signal path can include two or more mixers and can be arranged for quadrature down conversion and up conversion, respectively. In some implementations, the mixer circuitry 1206A of the receive signal path and the mixer circuitry 1206A of the transmit signal path can include two or more mixers and can be arranged for image rejection (e.g., Hartley image rejection). In some implementations, the mixer circuitry 1206A of the receive signal path and the mixer circuitry 1406A can be arranged for direct down conversion and direct up conversion, respectively. In some implementations, the mixer circuitry 1206A of the receive signal path and the mixer circuitry 1206A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1206 can include analog-to-digital converter (ADC) and digital-to-analog converter (DAC) circuitry and the baseband circuitry 1204 can include a digital baseband interface to communicate with the RF circuitry 1206.

In some dual-mode implementations, a separate radio IC circuitry can be provided for processing signals for each spectrum, although the scope of the implementations is not limited in this respect.

In some implementations, the synthesizer circuitry 1206D can be a fractional-N synthesizer or a fractional N/N+1 synthesizer, although the scope of the implementations is not limited in this respect as other types of frequency synthesizers can be suitable. For example, synthesizer circuitry 1206D can be a delta-sigma synthesizer, a frequency multiplier, or a synthesizer comprising a phase-locked loop with a frequency divider.

The synthesizer circuitry 1206D can be configured to synthesize an output frequency for use by the mixer circuitry 1206A of the RF circuitry 1206 based on a frequency input and a divider control input. In some implementations, the synthesizer circuitry 1206D can be a fractional N/N+1 synthesizer.

In some implementations, frequency input can be provided by a voltage-controlled oscillator (VCO), although that is not a requirement. Divider control input can be provided by either the baseband circuitry 1204 or the applications circuitry 1202 depending on the desired output frequency. In some implementations, a divider control input (e.g., N) can be determined from a look-up table based on a channel indicated by the applications circuitry 1202.

Synthesizer circuitry 1206D of the RF circuitry 1206 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1206D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1206 can include an IQ/polar converter.

FEM circuitry 1208 can include a receive signal path which can include circuitry configured to operate on RF signals received from one or more antennas 1210, amplify the received signals and provide the amplified versions of the received signals to the RF circuitry 1206 for further processing. FEM circuitry 1208 can also include a transmit signal path which can include circuitry configured to amplify signals for transmission provided by the RF circuitry 1206 for transmission by one or more of the one or more antennas 1210. In various implementations, the amplification through the transmit or receive signal paths can be done solely in the RF circuitry 1206, solely in the FEM circuitry 1208, or in both the RF circuitry 1206 and the FEM circuitry 1208.

In some implementations, the FEM circuitry 1208 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1206). The transmit signal path of the FEM circuitry 1208 can include a power amplifier (PA) to amplify input RF signals (e.g., provided by RF circuitry 1206), and one or more filters to generate RF signals for subsequent transmission (e.g., by one or more of the one or more antennas 1210).

In some implementations, the PMC 1212 can manage power provided to the baseband circuitry 1204. In particular, the PMC 1212 can control power-source selection, voltage scaling, battery charging, or DC-to-DC conversion. The PMC 1212 can often be included when the device 1200 is capable of being powered by a battery, for example, when the device is included in a UE. The PMC 1212 can increase the power conversion efficiency while providing desirable implementation size and heat dissipation characteristics.

While FIG. 12 shows the PMC 1212 coupled only with the baseband circuitry 1204. However, in other implementations, the PMC 1212 may be additionally or alternatively coupled with, and perform similar power management operations for, other components such as, but not limited to, application circuitry 1202, RF circuitry 1206, or FEM circuitry 1208.

In some implementations, the PMC 1212 can control, or otherwise be part of, various power saving mechanisms of the device 1200. For example, if the device 1200 is in an RRC_Connected state, where it is still connected to the RAN node as it expects to receive traffic shortly, then it can enter a state known as Discontinuous Reception Mode (DRX) after a period of inactivity. During this state, the device 1200 can power down for brief intervals of time and thus save power.

If there is no data traffic activity for an extended period of time, then the device 1200 can transition off to an RRC_Idle state, where it disconnects from the network and does not perform operations such as channel quality feedback, handover, etc. The device 1200 goes into a very low power state and it performs paging where again it periodically wakes up to listen to the network and then powers down again. The device 1200 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1202 and processors of the baseband circuitry 1204 can be used to execute elements of one or more instances of a protocol stack. For example, processors of the baseband circuitry 1204, alone or in combination, can be used execute Layer 3, Layer 2, or Layer 1 functionality, while processors of the baseband circuitry 1204 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

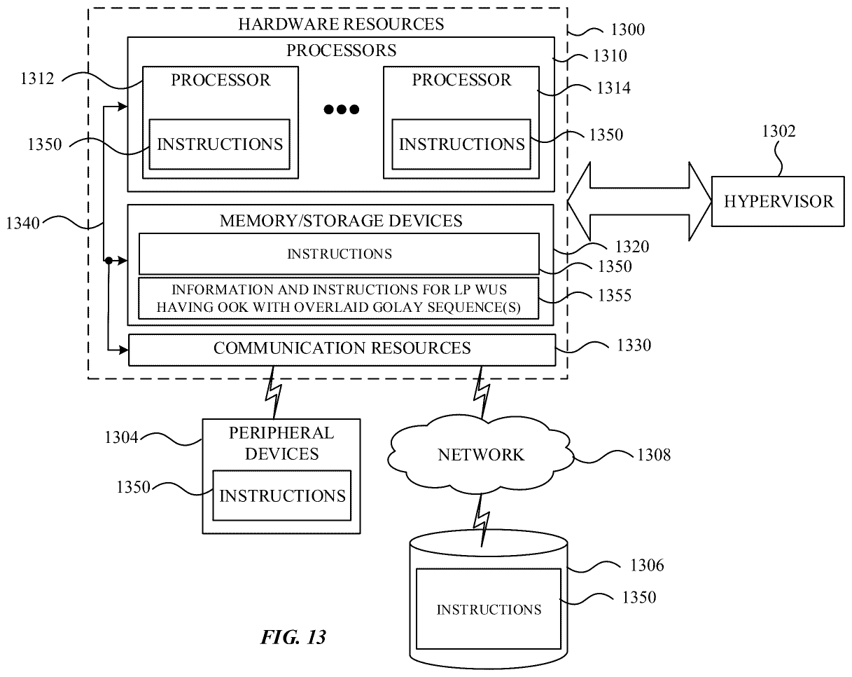

FIG. 13 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 13 shows a diagrammatic representation of hardware resources 1300 including one or more processors (or processor cores) 1310, one or more memory/storage devices 1320, and one or more communication resources 1330, each of which may be communicatively coupled via a bus 1340. For implementations where node virtualization (e.g., NFV) is utilized, a hypervisor may be executed to provide an execution environment for one or more network slices/sub-slices to utilize the hardware resources 1300.

The processors 1310 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1312 and a processor 1314.

The memory/storage devices 1320 may include main memory, disk storage, or any suitable combination thereof. The memory/storage devices 1320 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1320 receive and/or store information and instructions 1355 for enabling a LP-WUS to include OOK symbols with complementary sequences overlaying at least one of the OOK symbols. The complementary sequences may include an indication for UE 210 to transition from a power saving mode (e.g., an IDLE or INNACTIVE mode) to an active mode (e.g., a CONNECTED mode). Base station 222 may communicate the LP-WUS to UE 210, which may cause UE 210 to transition from the power saving mode to an active mode. The complementary sequence may include, or be generated creating, one or more Golay complementary sequences. Many other features and examples are discussed herein.

The communication resources 1330 may include interconnection or network interface components or other suitable devices to communicate with one or more peripheral devices 1304 or one or more databases 1306 via a network 1308. For example, the communication resources 1330 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1350 may comprise software, a program, an application, an applet, an app, or other executable code for causing at least any of the processors 1310 to perform any one or more of the methodologies discussed herein. The instructions 1350 may reside, completely or partially, within at least one of the processors 1310 (e.g., within the processor's cache memory), the memory/storage devices 1320, or any suitable combination thereof. Furthermore, any portion of the instructions 1350 may be transferred to the hardware resources 1300 from any combination of the peripheral devices 1304 or the databases 1306. Accordingly, the memory of processors 1310, the memory/storage devices 1320, the peripheral devices 1304, and the databases 1306 are examples of computer-readable and machine-readable media.

Examples and/or implementations herein may include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a base station may comprise memory; and one or more processors configured to, when executing instructions stored in the memory, cause the base station to: generate a low-power (LP) wake-up signal (LP-WUS), the LP-WUS comprising one or more on-off keying (OOK) symbols and one or more complementary sequences overlaying at least one OOK symbol of the one or more OOK symbols, the one or more complementary sequences comprising an indication of a user equipment (UE) to transition from a power saving mode to an active mode; and communicate the LP-WUS to the UE.

In example 2, which may also include one or more of the examples described herein, the one or more complementary sequences comprises at least one Golay complementary sequence. In example 3, which may also include one or more of the examples described herein, the at least one OOK symbol includes an indication for the UE to transition from the power saving mode to the active mode. In example 4, which may also include one or more of the examples described herein, the Golay complementary sequence is generated based on a pair of W and D vectors.

In example 5, which may also include one or more of the examples described herein, the one or more complementary sequences comprises a plurality of complementary sequences, and each complementary sequence of the plurality of complementary sequences is based on a common Golay complementary sequence and a different row of a Walsh-Hadamard matrix. In example 6, which may also include one or more of the examples described herein, the one or more complementary sequences comprises a plurality of complementary sequences, and each complementary sequence of the plurality of complementary sequences is based on a different Golay complementary sequence and a different row of a Walsh-Hadamard matrix.

In example 7, which may also include one or more of the examples described herein, a number of the one or more complementary sequences is based on a number of bits carried by the one or more complementary sequences. In example 8, which may also include one or more of the examples described herein, the base station is configured to coordinate a resource allocation, for the one or more complementary sequences, with one or more other base stations. In example 9, which may also include one or more of the examples described herein, the one or more complementary sequences corresponds to a set of Golay sequences that is different than sets of Golay sequences assigned to neighboring base stations. In example 10, which may also include one or more of the examples described herein, wherein the one or more complementary sequences corresponds to a hopping pattern associated with the base station.

In example 11, which may also include one or more of the examples described herein, a UE may comprise a memory; and one or more processors configured to, when executing instructions stored in the memory, cause the UE to: receive, from a base station, a low-power (LP) wake-up signal (LP-WUS), the LP-WUS comprising one or more on-off keying (OOK) symbols and one or more complementary sequences overlaying at least one OOK symbol of the one or more OOK symbols, the one or more complementary sequences comprising at least one indication of the UE to transition from a power saving mode to an active mode; and transition, in response to the LP-WUS, from a power saving mode to an active mode.

In example 12, which may also include one or more of the examples described herein, the one or more complementary sequences comprises at least one Golay complementary sequence. In example 13, which may also include one or more of the examples described herein, the at least one OOK symbol includes an indication for the UE to transition from the power saving mode to the active mode. In example 14, which may also include one or more of the examples described herein, the Golay complementary sequence is generated based on a pair of W and D vectors.

In example 15, which may also include one or more of the examples described herein, the one or more complementary sequences comprises a plurality of complementary sequences, and each complementary sequence of the plurality of complementary sequences is based on a common Golay complementary sequence and a different row of a Walsh-Hadamard matrix. In example 16, which may also include one or more of the examples described herein, the one or more complementary sequences comprises a plurality of complementary sequences, and each complementary sequence of the plurality of complementary sequences is based on a different Golay complementary sequence and a different row of a Walsh-Hadamard matrix.

In example 17, which may also include one or more of the examples described herein, a number of the one or more complementary sequences is based on a number of bits carried by the one or more complementary sequences. In example 18, which may also include one or more of the examples described herein, the one or more complementary sequences corresponds to a set of Golay sequences that is different than sets of Golay sequences assigned to neighboring base stations.

In example 19, which may also include one or more of the examples described herein, a baseband processor, comprising: one or more processors configured to: receive a low-power (LP) wake-up signal (LP-WUS) originating from a base station, the LP-WUS comprising one or more on-off keying (OOK) symbols and one or more complementary sequences overlaying at least one OOK symbol of the one or more OOK symbols, the one or more complementary sequences comprising at least one indication of a user equipment (UE) to transition from a power saving mode to an active mode; and transition, in response to the LP-WUS, from a power saving mode to an active mode. In example 20, which may also include one or more of the examples described herein, the one or more complementary sequences comprises at least one Golay complementary sequence.

The examples discussed above also extend to method, computer-readable medium, and means-plus-function claims and implementations, an of which may include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A base station, comprising:
a memory; and
one or more processors configured to, when executing instructions stored in the memory, cause the base station to:
generate a low-power (LP) wake-up signal (LP-WUS), the LP-WUS comprising one or more on-off keying (OOK) symbols and one or more complementary sequences overlaying at least one OOK symbol of the one or more OOK symbols, the one or more complementary sequences comprising an indication of a user equipment (UE) to transition from a power saving mode to an active mode; and
communicate the LP-WUS to the UE.

2. The base station of claim 1, wherein the one or more complementary sequences comprises at least one Golay complementary sequence.

3. The base station of claim 2, wherein the at least one OOK symbol includes an indication for the UE to transition from the power saving mode to the active mode.

4. The base station of claim 2, wherein the Golay complementary sequence is generated based on a pair of W and D vectors.

5. The base station of claim 1, wherein the one or more complementary sequences comprises a plurality of complementary sequences, and each complementary sequence of the plurality of complementary sequences is based on a common Golay complementary sequence and a different row of a Walsh-Hadamard matrix.

6. The base station of claim 1, wherein the one or more complementary sequences comprises a plurality of complementary sequences, and each complementary sequence of the plurality of complementary sequences is based on a different Golay complementary sequence and a different row of a Walsh-Hadamard matrix.

7. The base station of claim 1, wherein a number of the one or more complementary sequences is based on a number of bits carried by the one or more complementary sequences.

8. The base station of claim 1, wherein the base station is configured to coordinate a resource allocation, for the one or more complementary sequences, with one or more other base stations.

9. The base station of claim 1, wherein the one or more complementary sequences corresponds to a set of Golay sequences that is different than sets of Golay sequences assigned to neighboring base stations.

10. The base station of claim 1, wherein the one or more complementary sequences corresponds to a hopping pattern associated with the base station.

11. A user device (UE), comprising:
a memory; and
one or more processors configured to, when executing instructions stored in the memory, cause the UE to:
receive, from a base station, a low-power (LP) wake-up signal (LP-WUS), the LP-WUS comprising one or more on-off keying (OOK) symbols and one or more complementary sequences overlaying at least one OOK symbol of the one or more OOK symbols, the one or more complementary sequences comprising at least one indication of the UE to transition from a power saving mode to an active mode; and
transition, in response to the LP-WUS, from a power saving mode to an active mode.

12. The UE of claim 11, wherein the one or more complementary sequences comprises at least one Golay complementary sequence.

13. The UE of claim 12, wherein the at least one OOK symbol includes an indication for the UE to transition from the power saving mode to the active mode.

14. The UE of claim 12, wherein the Golay complementary sequence is generated based on a pair of W and D vectors.

15. The UE of claim 11, wherein the one or more complementary sequences comprises a plurality of complementary sequences, and each complementary sequence of the plurality of complementary sequences is based on a common Golay complementary sequence and a different row of a Walsh-Hadamard matrix.

16. The UE of claim 11, wherein the one or more complementary sequences comprises a plurality of complementary sequences, and each complementary sequence of the plurality of complementary sequences is based on a different Golay complementary sequence and a different row of a Walsh-Hadamard matrix.

17. The UE of claim 11, wherein a number of the one or more complementary sequences is based on a number of bits carried by the one or more complementary sequences.

18. The base station of claim 1, wherein the one or more complementary sequences corresponds to a set of Golay sequences that is different than sets of Golay sequences assigned to neighboring base stations.

19. A baseband processor, comprising:
one or more processors configured to:
receive a low-power (LP) wake-up signal (LP-WUS) originating from a base station, the LP-WUS comprising one or more on-off keying (OOK) symbols and one or more complementary sequences overlaying at least one OOK symbol of the one or more OOK symbols, the one or more complementary sequences comprising at least one indication of a user equipment (UE) to transition from a power saving mode to an active mode; and
transition, in response to the LP-WUS, from a power saving mode to an active mode.

20. The baseband processor of claim 19, wherein the one or more complementary sequences comprises at least one Golay complementary sequence.
